(19) United States
(12) Patent Application Publication
(10) Pub. No.: US 2025/0244753 A1
(43) Pub. Date: Jul. 31, 2025

(54) SYSTEMS AND METHODS FOR AUTOMATIC AND SELECTIVE QUALITY CONTROL USING HYBRID MACHINE LEARNING

(71) Applicant: Walmart Apollo, LLC, Bentonville, AR (US)

(72) Inventors: Faezeh Akhavizadegan, Mountain View, CA (US); Chia-Yen Ho, Cupertino, CA (US); Lawrence David Lin, San Francisco, CA (US); Yokila Arora, San Jose, CA (US); Topojoy Biswas, Pleasanton, CA (US); Sushant Kumar, San Jose, CA (US); Kannan Achan, Saratoga, CA (US)

(21) Appl. No.: 18/428,592

(22) Filed: Jan. 31, 2024

(51) Int. Cl. G05B 19/418

(52) U.S. Cl. CPC G05B 19/41875; G05B 2219/32368

(57) ABSTRACT

This application is directed to systems and methods for managing user actions with information items on a cloud-based information platform. In some embodiments, a disclosed method includes identifying a user action on one or more information items associated with one or more items; generating a user-churn score indicating a likelihood of failing to retain a first user associated with the user action using a user churn model; generating an item check score indicating a likelihood of the one or more items having a defect by an item check model; generating a quality check factor of the user action based on at least the item check score and the user-churn score; and based on the quality check factor, generating a quality check reminder message including an instruction to enter a user confirmation associated with the user action on a user interface displayed on an electronic device of a second user.

### TECHNICAL FIELD

This application relates generally to information processing and, more particularly, to systems and methods for generating selected requests for confirmation for actions associated with information items on a cloud-based information platform.

### BACKGROUND

A cloud-based information platform operates by presenting information items on a user interface and prompting user actions with a subset of the presented information items. In response to the user actions, the information platform often presents additional relevant information items or arranges services (e.g., shipping, delivery, and pickup) in real life to provide products related to information items associated with the user actions. These information or product services must be executed to a level that satisfies users' expectations to avoid losing valuable users. Many information platforms randomly select and track qualities of a small portion of these information and product services to represent their overall service quality. However, such selection is often inaccurate and cannot identify the most fallible information and product services. Although the overall service quality is tracked to some extent, most problems occurring to these information and product services cannot be accurately identified and corrected.

### SUMMARY

In various embodiments, a system including a non-transitory memory configured to store instructions thereon and at least one processor is disclosed. The at least one processor is configured to identify a user action associated with one or more information items corresponding to one or more items and obtain user information characterizing a first user associated with the user action, item information of the one or more items, and action information of the user action. The at least one processor is further configured to generate a user-churn score indicating a likelihood of failing to retain the first user, where the user-churn score is generated by a user churn model configured to receive the user information. The at least one processor is further configured to generate an item check score indicating a likelihood of the one or more items having a defect, where the item check score is generated by an item check model configured to receive the action information and the item information. The at least one processor is further configured to generate a quality check factor of the user action based on at least the item check score and the user-churn score, and in accordance with a determination that the quality check factor satisfies an item check criterion, generate a quality check reminder message including an instruction to enter a user confirmation associated with the user action on a user interface displayed on an electronic device of a second user.

In various embodiments, a computer-implemented method is disclosed. The computer-implemented method includes steps of identifying a user action associated with one or more information items corresponding to one or more items and obtaining user information characterizing a first user associated with the user action, item information of the one or more items, and action information of the user action. The computer-implemented method further includes a step of generating a user-churn score indicating a likelihood of failing to retain the first user, where the user-churn score is generated by a user churn model configured to receive the user information. The computer-implemented method further includes a step of generating an item check score indicating a likelihood of the one or more items having a defect, where the item check score is generated by an item check model configured to receive the action information and the item information. The computer-implemented method further includes a step of generating a quality check factor of the user action based on at least the item check score and the user-churn score. The computer-implemented method further includes a step of in accordance with a determination that the quality check factor satisfies an item check criterion, generating a quality check reminder message including an instruction to enter a user confirmation associated with the user action on a user interface displayed on an electronic device of a second user.

In various embodiments, a non-transitory computer readable medium having instructions stored thereon is disclosed. The instructions, when executed by at least one processor, cause at least one device to perform operations including identifying a user action associated with one or more information items corresponding to one or more items; obtaining user information characterizing a first user associated with the user action, item information of the one or more items, and action information of the user action; generating a user-churn score indicating a likelihood of failing to retain the first user, where the user-churn score is generated by a user churn model configured to receive the user information; generating an item check score indicating a likelihood of the one or more items having a defect, where the item check score is generated by an item check model configured to receive the action information and the item information; generating a quality check factor of the user action based on at least the item check score and the user-churn score; and in accordance with a determination that the quality check factor satisfies an item check criterion, generating a quality check reminder message including an instruction to enter a user confirmation associated with the user action on a user interface displayed on an electronic device of a second user.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 is a network environment configured to provide a user application to a plurality of tenants, in accordance with some embodiments;

FIG. 2 is a block diagram of a computing device, in accordance with some embodiments;

FIG. 3 illustrates an artificial neural network, in accordance with some embodiments;

FIG. 4 illustrates a tree-based artificial neural network, in accordance with some embodiments;

FIG. 5 illustrates a deep neural network (DNN), in accordance with some embodiments;

FIG. 6 is a flowchart illustrating a training method for generating a trained machine learning model, in accordance with some embodiments;

FIG. 7 is a process flow illustrating various steps of the training method of FIG. 6, in accordance with some embodiments;

FIG. 8A is a block diagram of a system that applies machine learning models to manage quality check associated with user actions, in accordance with some embodiments;

FIGS. 8B and 8C are diagrams illustrating user interfaces associated with the quality check managed by the system shown in FIG. 8A, in accordance with some embodiments;

FIG. 9 is a diagram illustrating a graphic user interface that displays a quality check reminder message, in accordance with some embodiments; and

FIG. 10 is a flowchart illustrating a method for managing user actions on information items, in accordance with some embodiments.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship. In the following, various embodiments are described with respect to the claimed systems as well as with respect to the claimed methods. Features, advantages or alternative embodiments herein can be assigned to the other claimed objects and vice versa. In other words, claims for the systems can be improved with features described or claimed in the context of the methods. In this case, the functional features of the method are embodied by objective units of the systems.

Various embodiments described herein are directed to systems and methods for automatically managing item quality checks made in response to user actions associated with an information item on a cloud-based information platform. A user application is executed to host a plurality of user accounts for a plurality of users (e.g., registered users, guest users) on the cloud-based information platform. The user application may present a plurality of information items associated with physical items (e.g., objects, products) from which users may be prompted to select to place a purchase order. When user actions with selected information items are detected, physical items associated with the respective information items are prepared in stores and/or warehouses, such that the physical items may be shipped to designated addresses and/or picked up by the users. Millions of user actions may occur within a limited duration of time (e.g., a day, a week), and it is not realistic to check quality of every individual physical item associated with every action, while random selection of physical items for quality check cannot identify missing, damaged, and/or expired items accurately. Once items arrive to a respective user, the users may file complaints or return the order, causing additional costs to the cloud-based information platform.

In some embodiments, hybrid machine learning models are applied to identify the physical items associated with the user actions selectively and automatically for quality check. Instructions may be generated to check missing, damaged, and/or expired items for selected users without delaying item pickup or delivery, thereby mitigating issues related to these compromised items and improving user satisfaction levels. In some embodiments, the hybrid machine learning models may be applied to identify both target users (e.g., high-value users) and target items (e.g., missing, damaged, and expired items) and generate quality check reminder messages identifying associated user actions automatically and in real time upon receiving the user actions during a quality control process. The hybrid machine learning models operate in the context of users, items, and orders to determine an item aggregation function that maps individual item scores S_{ITEM} to an item check score S_{IC} and a churn-item augmented quality check that results in an overall quality check factor S_{QC}, which help enhance user action selection (e.g., identifying certain users' certain orders). As such, the user actions that involve the target users and target items may be accurately identified, allowing focus of resources on sensitive user actions and manage quality control more efficiently. Particularly, when millions of user actions occur within a limited duration of time (e.g., a day, a week), the hybrid machine learning models can identify the sensitive user actions and provide quality check instructions in real time to a productive level that no human activities or prior computer technology can match.

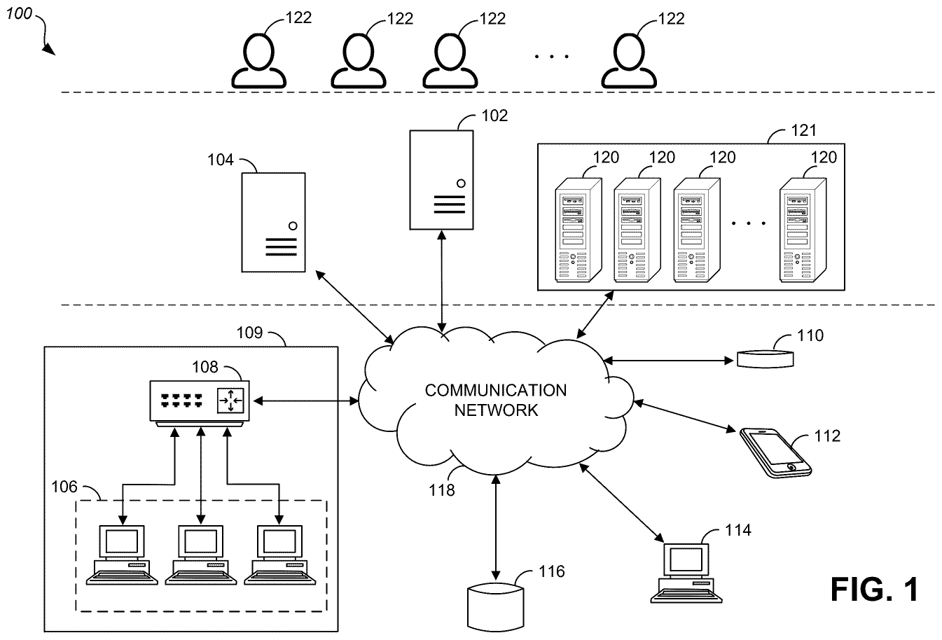

FIG. 1 is a network environment configured to provide a user application (e.g., a network interface application, an online shopping application, etc.) to a plurality of tenants, in accordance with some embodiments. The network environment 100 includes a plurality of devices or systems configured to communicate over one or more network channels, illustrated as a network cloud 118. For example, in various embodiments, the network environment 100 can include, but is not limited to, a computing device 102 (e.g., a server, such as an application server), a web server 104, a cloud-based engine 121 including one or more processing devices 120, workstation(s) 106, a database 116, and one or more user computing devices 110, 112, 114 operatively coupled over the network 118. The computing device 102, the web server 104, the workstation(s) 106, the processing device(s) 120, and the multiple user computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit and receive data over the communication network 118.

In some examples, each of the computing device 102 and the processing device(s) 120 can be a computer, a workstation, a laptop, a server such as a cloud-based server, or any other suitable device. In some examples, each of the processing devices 120 is a server that includes one or more processing units, such as one or more graphical processing units (GPUs), one or more central processing units (CPUs), and/or one or more processing cores. Each processing device 120 may, in some examples, execute one or more virtual machines. In some examples, processing resources (e.g., capabilities) of the one or more processing devices 120 are offered as a cloud-based service (e.g., cloud computing). For example, the cloud-based engine 121 may offer computing and storage resources of the one or more processing devices 120 to the computing device 102.

In some examples, each of the user computing devices 110, 112, 114 can be a cellular phone, a smart phone, a tablet, a personal assistant device, a voice assistant device, a digital assistant, a laptop, a computer, or any other suitable device. In some examples, the web server 104 hosts one or more network environments, or portions thereof, such as an e-commerce environment. In some examples, the computing device 102, the processing devices 120, and/or the web server 104 are operated by a network environment provider, and the multiple user computing devices 110, 112, 114 are operated by users 122 of the network environment. In some examples, the processing devices 120 are operated by a third party (e.g., a cloud-computing provider).

The workstation(s) 106 are operably coupled to the communication network 118 via a router (or switch) 108. The workstation(s) 106 and/or the router 108 may be located at a physical location 109, for example. The workstation(s) 106 can communicate with the computing device 102 over the communication network 118. The workstation(s) 106 may send data to, and receive data from, the computing device 102.

Although FIG. 1 illustrates three user computing devices 110, 112, 114, the network environment 100 can include any number of user computing devices 110, 112, 114. Similarly, the network environment 100 can include any number of the computing devices 102, the processing devices 120, the workstations 106, the web servers 104, and the databases 116.

The communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 118 can provide access to, for example, the Internet.

Each of the user computing devices 110, 112, 114 may communicate with the web server 104 over the communication network 118. For example, each of the user computing devices 110, 112, 114 may be operable to view, access, and interact with a website, such as an e-commerce website, hosted by the web server 104. The web server 104 may transmit user session data related to a user's activity (e.g., interactions) on the website. For example, a user may operate one of the user computing devices 110, 112, 114 to initiate a web browser that is directed to the website hosted by the web server 104. The user may, via the web browser, login to or otherwise interact with a software application or web application interface, for example. The website may capture these activities as user session data, and transmit the user session data to the computing device 102 over the communication network 118.

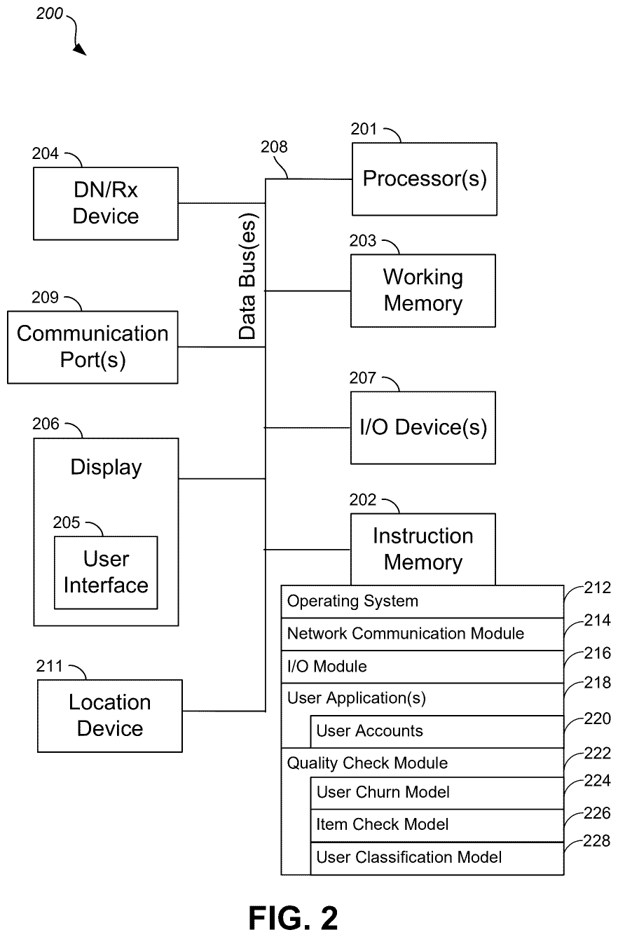

In some examples, the computing device 102 may execute one or more models, such as a user churn model (FIG. 2, 224), an item check model (FIG. 2, 226), etc., to identify first users and items associated with the first user's actions for item quality check. The computing device 102 may generate quality check reminder messages including instructions associated with the first user's actions, and transmit the quality check reminder messages to electronic devices of second users who may implement quality checks on the associated items. The quality check reminder messages are displayed on user interfaces of a user application executed on the electronic devices, prompting the second users to conduct quality check. The second users may enter the user confirmations regarding the quality check on the user interfaces in response to the instructions of the quality check reminder messages.

The computing device 102 is further operable to communicate with the database 116 over the communication network 118. For example, the computing device 102 can store data to, and read data from, the database 116. The database 116 can be a remote storage device, such as a cloud-based server, a disk (e.g., a hard disk), a memory device on another application server, a networked computer, or any other suitable remote storage. Although shown remote to the computing device 102, in some examples, the database 116 can be a local storage device, such as a hard drive, a non-volatile memory, or a USB stick. The computing device 102 may store purchase data received from the web server 104 in the database 116. The computing device 102 may also receive from the web server 104 user session data identifying events associated with browsing sessions, and may store the user session data in the database 116.

In some examples, the computing device 102 generates training data for one or more models (e.g., a user churn model 224, an item check model 226, and a user classification model 228 in FIG. 2, etc.) based on historical user session data, etc. The computing device 102 may train the models based on their corresponding training data and may store the model(s) in a database, such as in the database 116 (e.g., a cloud storage).

The models, when executed by the computing device 102, allow the computing device 102 to recommend items associated with a user action for quality check and generate a quality check reminder message including an instruction to enter a user confirmation associated with the user action on a user interface displayed on an electronic device of a second user. For example, the computing device 102 may obtain the models from the database 116. The computing device 102 may further execute the models (e.g., a user churn model 224 and an item check model 226 in FIG. 2) to process user information characterizing a first user, item information of one or more items, and action information of a user action, determine a quality check factor of the user action, and generate the quality check reminder message identifying the user action and associated items for quality check.

In some embodiments, the computing device 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some examples, the virtual machines assign each model (or part thereof) among a plurality of processing units. Based on the output of the models, computing device 102 may generate a quality check reminder message identifying a first user's action and including an instruction to enter a user confirmation associated with the user action on a user interface displayed on an electronic device of a second user distinct form the first user.

In some embodiments, the network environment 100 is configured to provide a user application (e.g., a network interface application, an online shopping application, etc.) to a plurality of users 122. An example of the plurality of users 122 is a plurality of users that share resources via the network environment 100. The user application is deployed for the plurality of users 122, and executed to process requests associated with the plurality of users 122 in the network environment 100 after the plurality of users 122 are authenticated and authorized to access the user application. For example, login pages are displayed on the workstation(s) 106 and the multiple customer computing devices 110, 112 and 114, allowing the plurality of users 122 to provide their credentials (e.g., user names, passwords). In some embodiments, upon authentication, requests associated with the plurality of users 122 (e.g., search requests, purchase requests, account review requests, item or action recommendation requests) are received from the workstation(s) 106 and customer computing devices 110, 112 and 114.

The network environment 100 is implemented to enable secure concurrent access experience by multiple users 122 of the user application. User interactions (e.g., queries, actions, etc.) of the plurality of users 122 are managed in a centralized manner by the computing device 102 and/or the cloud-based engine 121. In some embodiments, the computing device 102 and/or the cloud-based engine 121 identify a user action on one or more information items associated with one or more items and obtain user information characterizing a first user associated with the user action, item information of the one or more items, and action information of the user action. The computing device 102 and/or the cloud-based engine 121 apply machine learning to generate a user-churn score indicating a likelihood of failing to retain the first user and an item check score indicating a likelihood of the one or more items having a defect. The item check score and the user-churn score are combined to generate a quality check factor of the user action. In accordance with a determination that the quality check factor satisfies an item check criterion, the computing device 102 and/or the cloud-based engine 121 generate a quality check reminder message including an instruction to enter a user confirmation associated with the user action on a user interface displayed on an electronic device of a second user. Stated another way, the quality check reminder message requests the second user to manually check a quality of a purchase order associated with the first user's action and enter the user confirmation based on a quality check result.

FIG. 2 is a block diagram of a computing device 200, in accordance with some embodiments of the present teaching. In some embodiments, each of the computing device 102, the web server 104, the workstation(s) 106, the user computing devices 110, 112, 114, and/or the one or more processing devices 120 in FIG. 1 may include the features shown in FIG. 2. Referring to FIG. 2, the computing device 200 includes one or more of: one or more processors 201, a working memory 202, one or more input/output devices 207, an instruction memory 203, a transceiver 204, one or more communication ports 209, a display 206 with a user interface 205, and an optional location device 211, all operatively coupled to one or more data buses 208. The data buses 208 allow for communication among the various devices. The data buses 208 can include wired, or wireless, communication channels.

The processors 201 can include one or more distinct processors, each having one or more cores. Each of the distinct processors can have the same or different structure. The processors 201 can include one or more central processing units (CPUs), one or more graphics processing units (GPUs), application specific integrated circuits (ASICs), digital signal processors (DSPs), and the like.

The instruction memory 202 can store instructions that can be accessed (e.g., read) and executed by the processors 201. For example, the instruction memory 202 can be a non-transitory, computer-readable storage medium such as a read-only memory (ROM), an electrically erasable programmable read-only memory (EEPROM), flash memory, a removable disk, CD-ROM, any non-volatile memory, or any other suitable memory. The processors 201 can be configured to perform a certain function or operation by executing code, stored on the instruction memory 202, embodying the function or operation. For example, the processors 201 can be configured to execute code stored in the instruction memory 202 to perform one or more of any function, method, or operation disclosed herein.

Additionally, the processors 201 can store data to, and read data from, the working memory 202. For example, the processors 201 can store a working set of instructions to the working memory 202, such as instructions loaded from the instruction memory 202. The processors 201 can also use the working memory 202 to store dynamic data created during the operation of the computing device 102. The working memory 202 can be a random access memory (RAM) such as a static random access memory (SRAM) or dynamic random access memory (DRAM), or any other suitable memory.

The input-output devices 207 can include any suitable device that allows for data input or output. For example, the input-output devices 207 can include one or more of a keyboard, a touchpad, a mouse, a stylus, a touchscreen, a physical button, a speaker, a microphone, or any other suitable input or output device.

The communication port(s) 209 can include, for example, a serial port such as a universal asynchronous receiver/transmitter (UART) connection, a Universal Serial Bus (USB) connection, or any other suitable communication port or connection. In some examples, the communication port(s) 209 allows for the programming of executable instructions in the instruction memory 202. In some examples, the communication port(s) 209 allow for the transfer (e.g., uploading or downloading) of data, such as model training data.

The display 206 can be any suitable display, and may display the user interface 205. The user interfaces 205 can enable user interaction with the computing device 102. For example, the user interface 205 can be a user interface for an application of a retailer that allows a customer to view and interact with a retailer's website. In some examples, a user can interact with the user interface 205 by engaging the input-output devices 207. In some examples, the display 206 can be a touchscreen, where the user interface 205 is displayed on the touchscreen.

The transceiver 204 allows for communication with a network, such as the communication network 118 of FIG. 1. For example, if the communication network 118 of FIG. 1 is a cellular network, the transceiver 204 is configured to allow communications with the cellular network. In some examples, the transceiver 204 is selected based on the type of the communication network 118 the computing device 102 will be operating in. The processor(s) 201 is operable to receive data from, or send data to, a network, such as the communication network 118 of FIG. 1, via the transceiver 204.

The optional location device 211 may be communicatively coupled to one or more location services and/or devices and operable to receive position data from the corresponding location services. For example, the location device 211 may receive position data identifying a latitude, and longitude, from a satellite of a positioning constellation. Based on the position data, the computing device 102 may determine a local geographical area (e.g., town, city, state, etc.) of its position.

In some embodiments, the computing device 200 is configured to implement a user application for a plurality of users 122 via service deployment, service execution, self-learning and fine tuning, and session knowledge enrichment. In some embodiments, the working memory 203, or alternatively the non-transitory computer readable storage medium of memory 202, stores the following programs, modules and data structures, instructions, or a subset thereof:
Operating system 212 that includes procedures for handling various basic system services and for performing hardware dependent tasks;
Communication module 214 that is used for connecting the computing device 200 to other machines (e.g., other devices 102, 104, 120, 106, 110, 112, 114, and/or 116 in the network environment 100) via one or more network communication ports 209 (wired or wireless) and one or more communication networks 118, such as the Internet, other wide area networks, local area networks, metropolitan area networks, and so on;
I/O module 216 that includes procedures for handling various basic input and output functions through one or more input and output devices;
User application 218 that is executed to provide server-side functionalities, where an example of the user application 218 is an online interface application that may provide online services to registered users and/or guest users via a plurality of user accounts 220; and
Quality check module 222 that is executed to identify a first user's action associated with one or more information items that correspond to one or more items; apply machine learning models to process user information, item information, and action information of the user action and generate a quality check factor of the user action; and generate a quality check reminder message including an instruction to enter a user confirmation associated with the user action by a second user, where in some embodiments, the machine learning models includes a user-churn model for determining a user-churn score (e.g., a likelihood of failing to retain the first user) and an item check model for determining an item check score (e.g., a likelihood of the one or more items being missing, damaged, and defective).

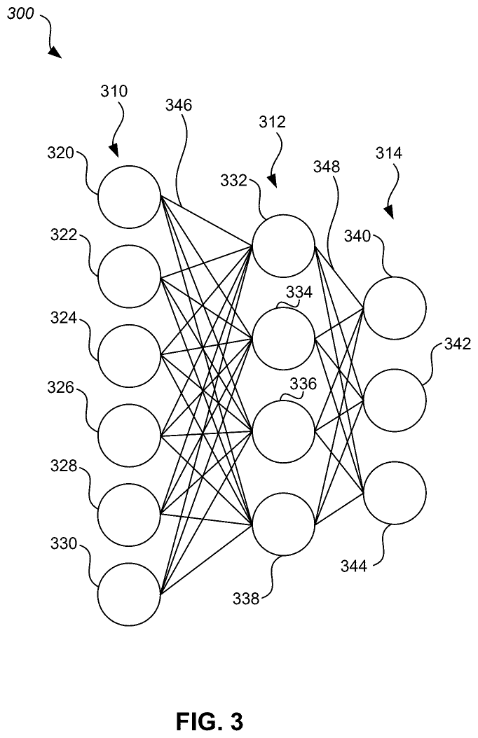

FIG. 3 illustrates an artificial neural network 300, in accordance with some embodiments. Alternative terms for “artificial neural network” are “neural network,” “artificial neural net,” “neural net,” or “trained function.” The neural network 300 comprises nodes 320-344 and edges 346-348, wherein each edge 346-348 is a directed connection from a first node 320-338 to a second node 332-344. In general, the first node 320-338 and the second node 332-344 are different nodes, although it is also possible that the first node 320-338 and the second node 332-344 are identical. For example, in FIG. 3 the edge 346 is a directed connection from the node 320 to the node 332, and the edge 348 is a directed connection from the node 332 to the node 340. An edge 346-348 from a first node 320-338 to a second node 332-344 is also denoted as “ingoing edge” for the second node 332-344 and as “outgoing edge” for the first node 320-338.

The nodes 320-344 of the neural network 300 may be arranged in layers 310-314, wherein the layers may comprise an intrinsic order introduced by the edges 346-348 between the nodes 320-144 such that edges 346-348 exist only between neighboring layers of nodes. In the illustrated embodiment, there is an input layer 310 comprising only nodes 320-330 without an incoming edge, an output layer 314 comprising only nodes 340-344 without outgoing edges, and a hidden layer 312 in-between the input layer 310 and the output layer 314. In general, the number of hidden layer 312 may be chosen arbitrarily and/or through training. The number of nodes 320-330 within the input layer 310 usually relates to the number of input values of the neural network, and the number of nodes 340-344 within the output layer 314 usually relates to the number of output values of the neural network.

In particular, a (real) number may be assigned as a value to every node 320-344 of the neural network 300. Here, xᵢ^{(u)} denotes the value of the i-th node 320-344 of the n-th layer 310-314. The values of the nodes 320-330 of the input layer 310 are equivalent to the input values of the neural network 300, the values of the nodes 340-344 of the output layer 314 are equivalent to the output value of the neural network 300. Furthermore, each edge 346-348 may comprise a weight being a real number, in particular, the weight is a real number within the interval [−1, 1], within the interval [0, 1], and/or within any other suitable interval. Here, w_{i,j}^{(m,n)} denotes the weight of the edge between the i-th node 320-338 of the m-th layer 310, 312 and the j-th node 332-344 of the n-th layer 312, 314. Furthermore, the abbreviation w_{i,j}⁽ⁿ⁾ is defined for the weight w_{i,j}^{(n,n+1)}.

In particular, to calculate the output values of the neural network 300, the input values are propagated through the neural network. In particular, the values of the nodes 332-344 of the (n+1)-th layer 312, 314 may be calculated based on the values of the nodes 320-338 of the n-th layer 310, 312 by:

$${x}_{j}^{( n + 1 )} = f ( {\sum }_{i} {x}_{i}^{( n )} \cdot {w}_{i , j}^{( n )} ) \qquad ( 1 )$$

where the function f is a transfer function (another term is “activation function”). Known transfer functions are step functions, sigmoid function (e.g., the logistic function, the generalized logistic function, the hyperbolic tangent, the Arctangent function, the error function, the smooth step function) or rectifier functions. The transfer function is mainly used for normalization purposes.

In particular, the values are propagated layer-wise through the neural network, wherein values of the input layer 310 are given by the input of the neural network 300, wherein values of the hidden layer(s) 312 may be calculated based on the values of the input layer 310 of the neural network and/or based on the values of a prior hidden layer, etc.

In order to set the values w_{i,j}^{(m,n)} for the edges, the neural network 300 has to be trained using training data. In particular, training data comprises training input data and training output data. For a training step, the neural network 300 is applied to the training input data to generate calculated output data. In particular, the training data and the calculated output data comprise a number of values, said number being equal with the number of nodes of the output layer.

In particular, a comparison between the calculated output data and the training data is used to recursively adapt the weights within the neural network 300 (backpropagation algorithm). In particular, the weights are changed according to

$${w}_{i , j}^{′ ( n )} = {w}_{i , j}^{( n )} - γ \cdot {δ}_{j}^{( n )} \cdot {x}_{i}^{( n )} \qquad ( 2 )$$

wherein γ is a learning rate, and the numbers δᵢ⁽ⁿ⁾ may be recursively calculated as

$${δ}_{j}^{( n )} = ( {\sum }_{k} {δ}_{k}^{( n + 1 )} \cdot {w}_{j , k}^{( n + 1 )} ) \cdot {f}^{′} ( {\sum }_{i} {x}_{i}^{( n )} \cdot {w}_{i , j}^{( n )} ) \qquad ( 3 )$$

based on δⱼ⁽ⁿ⁺¹⁾, if the (n+1)-th layer is not the output layer, and

$${δ}_{j}^{( n )} = ( {x}_{k}^{( n + 1 )} - {t}_{j}^{( n + 1 )} ) \cdot {f}^{′} ( {\sum }_{i} {x}_{i}^{( n )} \cdot {w}_{i , j}^{( n )} ) \qquad ( 4 )$$

if the (n+1)-th layer is the output layer 34, wherein f′ is the first derivative of the activation function, and yⱼ⁽ⁿ⁺¹⁾ is the comparison training value for the j-th node of the output layer 314.

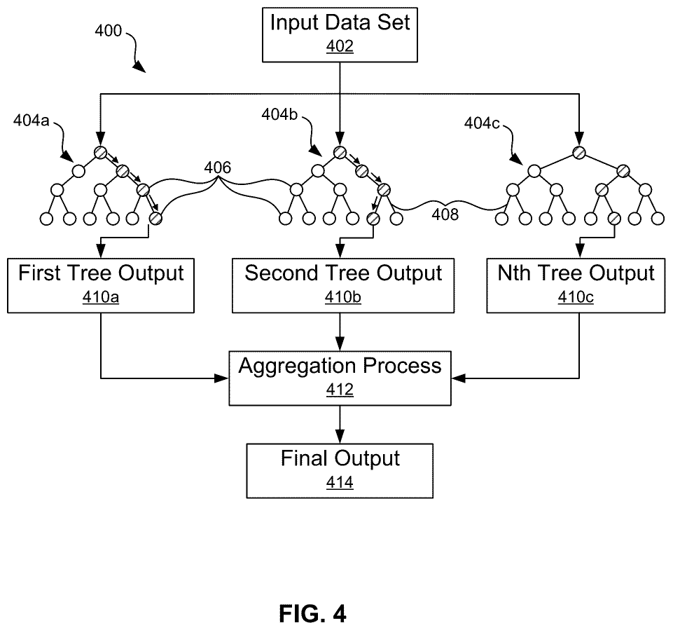

FIG. 4 illustrates a tree-based neural network 400, in accordance with some embodiments. In particular, the tree-based neural network 400 is a random forest neural network, though it will be appreciated that the discussion herein is applicable to other decision tree neural networks. The tree-based neural network 400 includes a plurality of trained decision trees 404a-404c each including a set of nodes 406 (also referred to as “leaves”) and a set of edges 408 (also referred to as “branches”).

Each of the trained decision trees 404a-404c may include a classification and/or a regression tree (CART). Classification trees include a tree model in which a target variable may take a discrete set of values, e.g., may be classified as one of a set of values. In classification trees, each leaf 406 represents class labels and each of the branches 408 represents conjunctions of features that connect the class labels. Regression trees include a tree model in which the target variable may take continuous values (e.g., a real number value).

In operation, an input data set 402 including one or more features or attributes is received. A subset of the input data set 402 is provided to each of the trained decision trees 404a-404c. The subset may include a portion of and/or all of the features or attributes included in the input data set 402. Each of the trained decision trees 404a-404c is trained to receive the subset of the input data set 402 and generate a tree output value 410a-410c, such as a classification or regression output. The individual tree output value 410a-410c is determined by traversing the trained decision trees 404a-404c to arrive at a final leaf (or node) 406.

In some embodiments, the tree-based neural network 400 applies an aggregation process 412 to combine the output of each of the trained decision trees 404a-404c into a final output 414. For example, in embodiments including classification trees, the tree-based neural network 400 may apply a majority-voting process to identify a classification selected by the majority of the trained decision trees 404a-404c. As another example, in embodiments including regression trees, the tree-based neural network 400 may apply an average, mean, and/or other mathematical process to generate a composite output of the trained decision trees. The final output 414 is provided as an output of the tree-based neural network 400.

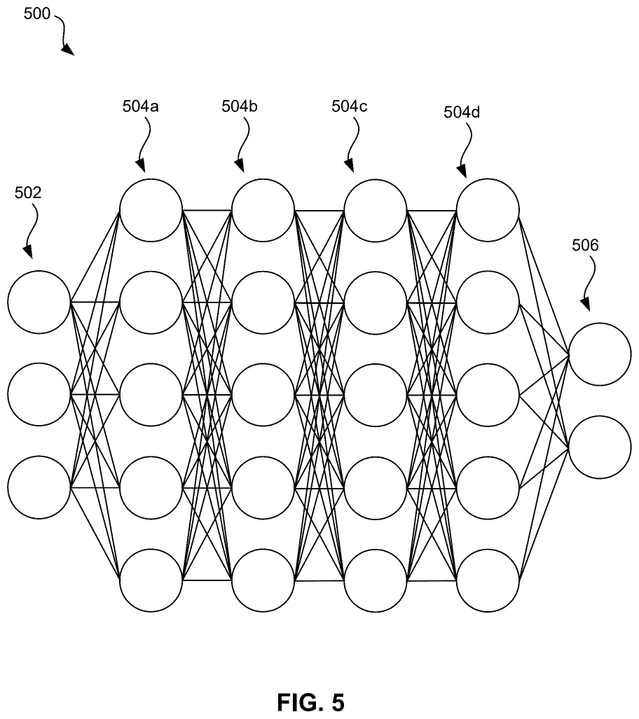

FIG. 5 illustrates a deep neural network (DNN) 500, in accordance with some embodiments. The DNN 500 is an artificial neural network, such as the neural network 300 illustrated in conjunction with FIG. 3, that includes representation learning. The DNN 500 may include an unbounded number of (e.g., two or more) intermediate layers 504a-504d each of a bounded size (e.g., having a predetermined number of nodes), providing for practical application and optimized implementation of a universal classifier. Each of the layers 504a-504d may be heterogenous. The DNN 500 may be configured to model complex, non-linear relationships. Intermediate layers, such as intermediate layer 504c, may provide compositions of features from lower layers, such as layers 504a, 504b, providing for modeling of complex data.

In some embodiments, the DNN 500 may be considered a stacked neural network including multiple layers each configured to execute one or more computations. The computation for a network with L hidden layers may be denoted as:

$$f ( x ) = f [ {a}^{( L + 1 )} ( {h}^{( L )} ( {a}^{( L )} ( ... ( {h}^{( 2 )} ( {a}^{( 2 )} ( {h}^{( 1 )} ( {a}^{( 1 )} ( x ) ) ) ) ) ) ) ) ] \qquad ( 5 )$$

where a^{(l)}(x) is a preactivation function and h^{(l)}(x) is a hidden-layer activation function providing the output of each hidden layer. The preactivation function a^{(l)}(x) may include a linear operation with matrix W^{(l)} and bias b^{(l)}, where:

$${a}^{( l )} ( x ) = {W}^{( l )} x + {b}^{( l )} \qquad ( 6 )$$

In some embodiments, the DNN 500 is a feedforward network in which data flows from an input layer 502 to an output layer 506 without looping back through any layers. In some embodiments, the DNN 500 may include a backpropagation network in which the output of at least one hidden layer is provided, e.g., propagated, to a prior hidden layer. The DNN 500 may include any suitable neural network, such as a self-organizing neural network, a recurrent neural network, a convolutional neural network, a modular neural network, and/or any other suitable neural network.

In some embodiments, a DNN 500 may include a neural additive model (NAM). An NAM includes a linear combination of networks, each of which attends to (e.g., provides a calculation regarding) a single input feature. For example, a NAM may be represented as:

$$y = β + {f}_{1} ( {x}_{1} ) + {f}_{2} ( {x}_{2} ) + … + {f}_{K} ( {x}_{K} ) \qquad ( 7 )$$

where β is an offset and each fᵢ is parametrized by a neural network. In some embodiments, the DNN 500 may include a neural multiplicative model (NMM), including a multiplicative form for the NAM mode using a log transformation of the dependent variable y and the independent variable x:

$$y = {e}^{β} {e}^{f ( logx )} {e}^{{\sum }_{i} {f}_{i}^{d} ( {d}_{i} )} \qquad ( 8 )$$

where d represents one or more features of the independent variable x.

It will be appreciated that automated quality check determination processes including user action identification and message generation, as disclosed herein, particularly for large platforms such as e-commerce network platforms, is only possible with the aid of computer-assisted machine-learning algorithms and techniques, such as the disclosed user churn model 224 or item check model 226 (FIG. 2). In some embodiments, during the quality check determination processes, the trained churn model 224 and item check model 226 are implemented to perform operations that cannot practically be performed by a human, either mentally or with assistance. Such operations include, but not limited to, automated extraction of user information, item information, and action information from a database (e.g., a database 116 in FIG. 1), determination of a quality check factor in the context of users, items, and actions, and generation of a quality check reminder message including an instruction associated with the user action. In some situations, information of millions of users, items, and actions may need to be processed within a short duration of time (e.g., within a day), which cannot practically be processed by human (e.g., a group of people) within a reasonable time frame and with a desirable accuracy level. It will be appreciated that a variety of quality check determination techniques can be used alone or in combination to identify user actions for which quality check is needed and generate associated quality check reminder messages automatically.

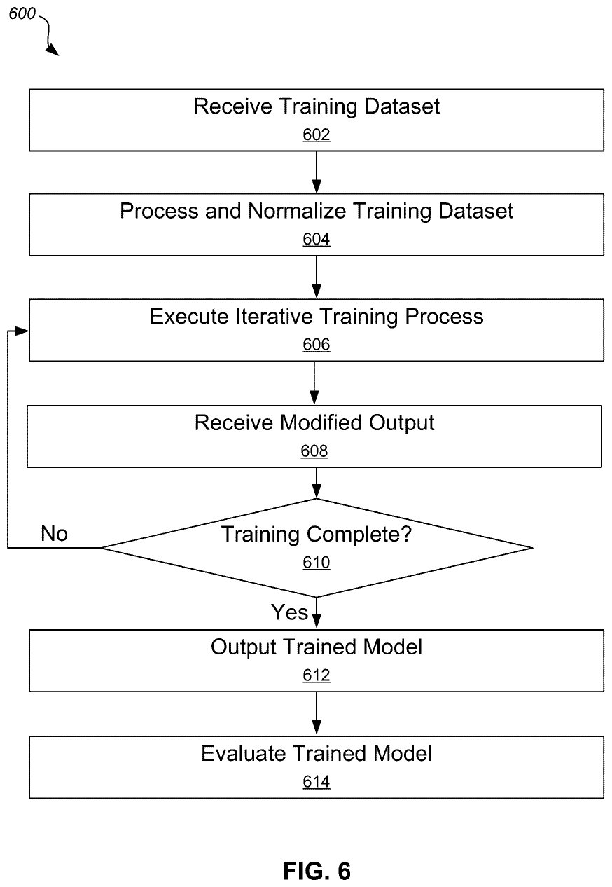

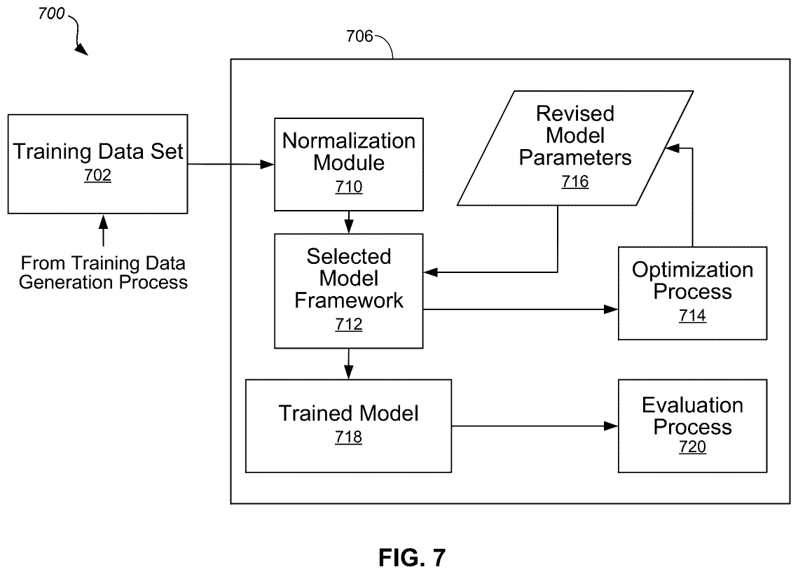

In some embodiments, a quality check determination method can include and/or implement one or more trained models, such as a user churn model 224 and an item check model 226. In some embodiments, one or more trained models can be generated using an iterative training process based on a training dataset. FIG. 6 illustrates a method 600 for generating a trained model, such as a trained optimization model, in accordance with some embodiments. FIG. 7 is a process flow 700 illustrating various steps of the method 600 of generating a trained model (e.g., a trained user churn model 224 and a trained item check model 226 in FIG. 2), in accordance with some embodiments. At step 602, a training dataset 702 is received by a system 706, such as a processing device 120. The training dataset 702 can include labeled and/or unlabeled data. For example, in some embodiments, a set of training data is provided for use in training a model, as discussed above.

At optional step 604, the received training dataset 702 is processed and/or normalized by a normalization module 710. For example, in some embodiments, the training dataset 702 can be augmented by imputing or estimating missing values or features of one or more screenshots.

At step 606, an iterative training process is executed to train a selected model framework 712. The selected model framework 712 can include an untrained (e.g., base) user churn model 224 or item check model 226, such as a DNN-based framework and/or a partially or previously trained model (e.g., a prior version of a trained model). The training process is configured to iteratively adjust parameters (e.g., hyperparameters) of the selected model framework 712 to minimize a cost value (e.g., an output of a cost function) for the selected model framework 712.

At step 608, the training process is an iterative process that generates set of revised model parameters 716 and the output of the cost function during each iteration. The set of revised model parameters 716 can be generated by applying an optimization process 714 to the cost function of the selected model framework 712. The optimization process 714 can be configured to reduce the cost value (e.g., reduce the output of the cost function) at each step by adjusting one or more parameters during each iteration of the training process.

After each iteration of the training process, at step 610, a determination is made whether the training process is complete. The determination at step 610 can be based on any suitable parameters. For example, in some embodiments, a training process can complete after a predetermined number of iterations. As another example, in some embodiments, a training process can complete when it is determined that the cost function of the selected model framework 712 has reached a minimum, such as a local minimum and/or a global minimum.

At step 612, a trained model 718 is output and provided for use in determining a user-churn score indicating a likelihood of failing to retain a user and an item check score indicating a likelihood of the one or more items having a defect. At optional step 614, a trained model 718 can be evaluated by an evaluation process 720. A trained model can be evaluated based on any suitable metrics, such as, for example, an F or F1 score, normalized discounted cumulative gain (NDCG) of the model, mean reciprocal rank (MRR), mean average precision (MAP) score of the model, and/or any other suitable evaluation metrics. Although specific embodiments are discussed herein, it will be appreciated that any suitable set of evaluation metrics can be used to evaluate a trained model.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

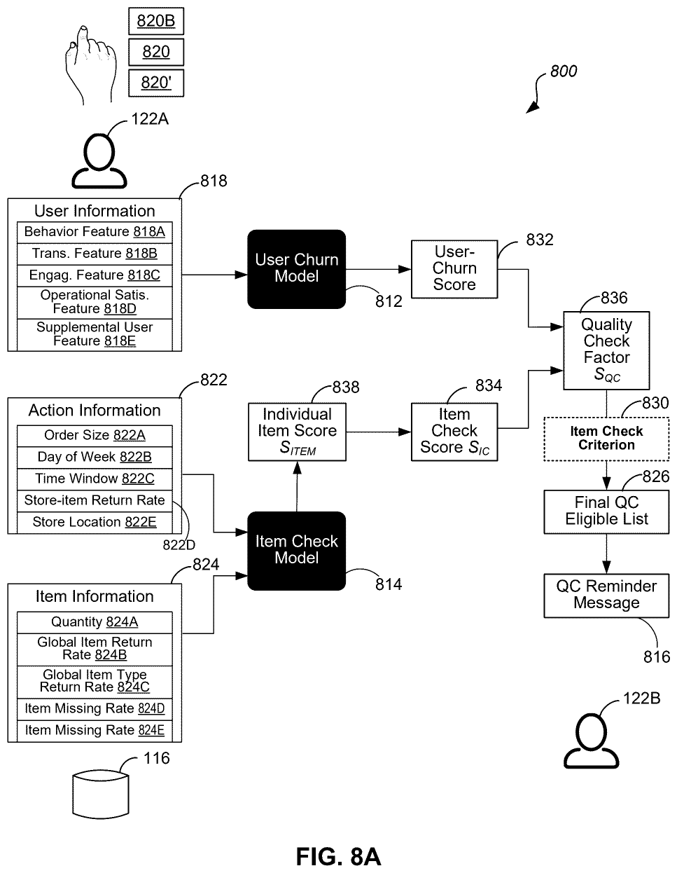

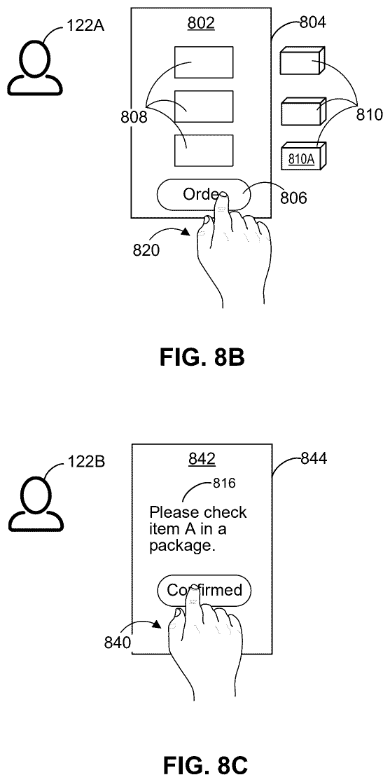

FIG. 8A is a block diagram of a system 800 that applies machine learning models to manage quality check associated with user actions, in accordance with some embodiments. FIGS. 8B and 8C are diagrams illustrating user interfaces 802 and 842 associated with the quality check managed by the system 800 shown in FIG. 8A, in accordance with some embodiments. The system 800 may include a computing device 102 and/or a cloud-based engine 121. The system 800 may execute a user application 218 (FIG. 2) via an Internet browser or a dedicated application and generate instructions to display a user interface 802 on an electronic device 804 associated with a first user 122A (FIG. 8B). A user action 820 of the first user 122 is received via the user interface 802. In an example, the user interface 802 may display an actionable information item 806 (e.g., “order”) and one or more information items 808. The first user 122A clicks on the actionable information item 806 to create an order for the one or more items 810 corresponding to the one or more information items 808 displayed on the user interface 802. A quality check module 222 (FIG. 2) of the system 800 is configured to detect the first user's action 820 associated with the one or more information items 808 and determine whether to request a quality check for at least one item 810A associated with the user action 820. Particularly, the system 800 may apply both a user churn model 812 and an item check model 814 (FIG. 8A) to determine that the first user's action 820 associated with the at least one item 810A satisfies an item check criterion 830, and therefore, generate a quality check reminder message 816 (FIG. 8C) including an instruction associated with the quality check of the at least one item 810A.

Referring to FIG. 8A, in some embodiments, user information 818 of the first user 122A, item information 824 of the one or more items 810, and action information 822 of the user action 820 may be obtained (e.g., extracted from a database 116 in FIG. 1), after the user action 820 associated with the one or more information items 808 corresponding to one or more items 810 is identified. A user-churn score 832 indicates a likelihood of failing to retain the first user 122A and may be generated by the user churn model 812 using at least the user information 818. An item check score 834 indicates a likelihood of the one or more items 810 having a defect (e.g., broadly including at least one item that is missing, damaged, or defective). The item check score 834 may be generated by the item check model 814 based on the action information 822 and the item information 824. A quality check factor 836 of the user action 820 is generated based on at least the item check score 834 and the user-churn score 832. In accordance with a determination that the quality check factor 836 satisfies the item check criterion 830, the quality check reminder message 816 is generated. The message 816 includes an instruction to enter a user confirmation 840 associated with the user action 820 on a user interface 842 displayed on an electronic device 844 of a second user 122B (FIG. 8C).

The user action 820 may initiate an order request for the one or more items 810 corresponding to the one or more information items 808 for a user account associated with the first user 122A. In some embodiments, the action information 822 describes the user action 820 and is associated with the order request enabled by the user action 820 for the one or more items 810 corresponding to the one or more information items 808. The user information 818 may include one or more of: an order size 822A, an order day in a week 822B, an order time window 822C in a day, an order store, a store location 822E, and an associated store-item return rate 822D of the order store associated with the user action 820. The item information 824 of each of the one or more items 810 may include one or more of: an item quantity 824A, a global item return rate 824B, a global item type return rate 824C, an item missing rate 824D associated with an order size, an item missing rate 824E associated with the item quantity 824A of a respective item 810 associated with the user action 820.

Referring to FIG. 8C, in some embodiments, the second user 122B is a store clerk or a warehouse worker. The store clerk or warehouse worker may have prepared and receive the message 816 to check, the one or more items 810 in response to the first user's action 820. The store clerk or warehouse worker may be assigned simply to check the one or more items 810 prepared by another worker in response to the first user's action 820. Upon reading the quality check reminder message 816 on the user interface 842, the store clerk or warehouse worker may physically check whether a package prepared in response to the user action 820 includes any missing, damaged, or defective item. Further, in some embodiments, the one or more items 810 prepared in response to the user action 820 will not be shipped, delivered, or put on shelf for a pickup before the store clerk or warehouse worker enters the user confirmation 840 on the user interface 842.

Referring to FIG. 8A, in some embodiments, the item check model 814 is applied to process the action information 822 and the item information 824 jointly to generate one or more individual item scores 838 and each individual item score 838 indicates a likelihood of a respective item being missing, damaged, or defective. The one or more individual item scores 838 correspond to one or more items 810 associated with the user action 820 and are combined to generate the item check score 834. Further, in some embodiments, a logarithm based value LV is generated for each individual item score 838 and the item check score 834 is further generated based on a sum of the logarithm based values of the one or more individual item scores 838. The item check score 834 (S_{IC}) may be represented by the individual item scores 838 (S_{ITEM}) as follows:

$${S}_{IC} = - {\sum }_{i = 0}^{N} {LV}_{i} = - {\sum }_{i = 0}^{N} log ( 1 - {S}_{ITEM , i} ) \qquad ( 7 )$$

where the user action 820 is associated with, and the one or more items 810 include, an integer number (N) of items.

In some embodiments, the item check model 814 may be a logistic regression model. A quality check needs to be performed for the one or more items 810 that are associated with the user action 820 and have a relatively high probability of being returned by the first user 122A. A quality check rate of all user actions that are associated with item orders may be controlled at a level (e.g., 2% of all item orders). The logistic model models log-odds of the quality check (e.g., corresponding to the one or more items 810) as a linear combination of one or more independent variables (e.g., action information 822, item information 824). The logistic regression model is applied to estimate coefficients applied in the linear combination of the associated logistic model. In an example, the coefficients of the linear combination of the logistic model are estimated by maximum-likelihood estimation (MLE).

Alternatively, in some embodiments, the item check model 814 may be a random forest model that is applied as an ensemble learning method for identifying a subset of a plurality of user actions (e.g., user action 820) for which associated items need to be checked. A multitude of decision trees may be constructed at a training time. The random forest model enables binary classification in which the user action 820 is associated with a quality check or no quality check. When classified to with a class associated with quality check, a quality check reminder message 816 may be generated and presented on the user interface 842 displayed on the electronic device 844 of the second user 122B, instructing the second user 122B to conduct quality check and enter a user confirmation 840 associated with the user action 820.

In some embodiments, the user churn model 812 is applied to process the user information 818 to generate the user-churn score 832 (S_{CHURN}), which indicates a likelihood of failing to retain the first user 122A associated with the user action 820. The user information 818 may be stored in the database 116 (FIG. 1). Further, in some embodiments, the user information 818 includes a user class to which the first user 122A is classified by a user classification model 228 (FIG. 2) based on historic interaction data of the first user 122A. In some embodiments, the user information includes one or more of: a behavior feature 818A, a transaction feature 818B, an engagement feature 818C, an operational satisfaction feature 818D, and a supplemental user feature 818E of the first user 122A. The behavior feature 818A may include at least one of: a persona class, a most recent visit time, a visit frequency, and a monetization rate. The transaction feature 818B may include at least one of: a number of completed transactions, a gross monetization value, and an average order value. The engagement feature 818C may include at least one of: historic search data, historic browsing or click data, historic impressions, and historic add-to-cart (ATC) data. Historic impressions include content that have been presented in the first user's view. The operational satisfaction feature 818D may include at least one of: a number of customer care contacts, an order cancellation ratio, a number of returns, details of previous returns, and comments provided to bought items. The supplemental user feature 818E may include one or more anonymized user features. The user information 818 is provided by the plurality of users 122 including the first user 122A or generated based on previous user actions of the plurality of users 122 on the user application 218. For example, in accordance with a determination that the first user 122A has clicked on information items 808 representing female clothes, the first user 122A is identified as a female user gender with a high confidence score, and gender information of the supplemental user feature 818E includes a gender indicator value associated with the female user and the high confidence score.

The user-churn score 832 (S_{CHURN}) and the item check score 834 (S_{IC}) may be combined to generate the quality check factor 836 (S_{QC}) as follows:

$${S}_{QC} = - {w}_{1} log ( 1 - {e}^{( 1 - \frac{1}{{S}_{CHURN}} )} ) - {w}_{2} log ( 1 - {e}^{( 1 - \frac{1}{{S}_{IC}} )} ) + {w}_{3} log ( N ) \qquad ( 8 )$$

where w₁, w₂, and w₃ are weights of a user-churn term, an item check term, and an item number term. Stated another way, in some embodiments, the user-churn term is determined based on the user-churn score 832 (S_{CHURN}), and the item check term is determined based on the item check score 834 (S_{IC}). The item number term is determined based on the number (N) of items associated with the user action 820. The quality check factor 836 (S_{QC}) is a weighted combination of a logarithm of the user-churn term, a logarithm of the item check term, and a logarithm of the number (N) of items associated with the user action 820. In some embodiments, the quality check factor 836 (S_{QC}) is generated based on the number (N) of items of the one or more items 810 associated with the user action 820. For example, the quality check factor 836 (S_{QC}) includes the item number term, which may be a logarithm of the number (N) of items associated with the user action 820. The more the number (N) of items associated with the user action 820, the higher the quality check factor 836 (S_{QC}), and the higher a chance of implementing a quality check on the items 810 associated with the user action 820.

In some embodiments, each of the user churn model 812 and the item check model 814 is trained independently of each other. In some embodiments, the user churn model 812, the item check model 814, and weights (w₁, w₂, and w₃) used to determine the quality check factor 836 (Sec) are trained in an end-to-end manner based on historic transaction data stored in a database 116. In some embodiments, the weights (w₁, w₂, and w₃) are statistically determined. In some embodiments, a training dataset 702 (FIG. 7) is applied to train the user churn model 812, the item check model 814, and/or the weights (w₁, w₂, and w₃), and are obtained or generated from historic user action data associated with historic user actions of a plurality of users 122 during a duration of time (e.g., during past three months).

The user action 820 is classified to a quality check class and a no check class. A ground truth may be set forth requiring that a predefined portion (e.g., 2%) of the historic user actions is classified to the quality check class and that a remainder of the predefined portion (e.g., 98%) is classified to the no check class. In some embodiments, the system may apply one of a PR curve and a ROC curve to control model training. The PR curve shows a tradeoff between precision and recall for different classification thresholds. A high area under the curve represents both high recall and high precision, where high precision relates to a low false positive rate, and high recall relates to a low false negative rate. The ROC curve may be plotted on a graph showing performance of the classification model at classification thresholds. This ROC curve may indicate two parameters including a true positive rate and a false positive rate. More details on a neural network applied in the item check model 814 or the user churn model 812 are explained above with reference to FIGS. 3-7.

After the quality check factor 836 (S_{QC}) is generated, the item check criterion 830 may be applied to determine whether the quality check factor 836 (S_{QC}) triggers generation of the quality check reminder message 816. In some embodiments, the item check criterion 830 defines a quality check threshold QC_{TH} based on a predefined portion of historic orders during a duration of time. For example, the quality check factor 836 (S_{QC}) is determined for historic orders associated with historic user actions by a plurality of users 122 during a duration of three months. The quality check threshold QC_{TH} is defined to be lower than the quality check factors 836 (S_{QC}) of the predefined portion (e.g., 2%) of the quality check factor 836 (S_{QC}) measured every day. The quality check reminder message 816 is generated in accordance with a determination that the quality check factor 836 (S_{QC}) is greater than the quality check threshold QC_{TH}. Stated another way, the quality check threshold QC_{TH} is selected to implement quality check on items 810 associated with the predefined portion (e.g., 2%) of the user actions every day.

In some embodiments, the quality check threshold QC_{TH} defined by the item check criterion 830 may be dynamically adjusted. A current quality check capability may be determined for the system 800, and the quality check threshold QC_{TH} is dynamically adjusted based on the current quality check capability. In some situations, the current quality check capability is entered by an authorized user account associated with a supervisor user. The supervisor user may check an overall labor availability level or a store's or a warehouse's labor available level for quality check, and enter the current quality check capability into the user application 218. The quality check threshold QC_{TH} may be adjusted automatically based on the current quality check capability. The quality check reminder message 816 is generated in accordance with a determination that the quality check factor 836 (S_{QC}) is greater than the adjusted quality check threshold QC_{TH}.

In some embodiments, a plurality of user actions 820′ are identified by the system 800, and each user action 820′ is associated with a respective user and one or more respective items corresponding to one or more items. Values of the quality check factor 836 (S_{QC}) associated with a first subset of the user actions 820′ satisfy the item check criterion 830, and items corresponding to the first subset of the user actions 820′ are added to a quality check eligible list 826. For each the first subset of the user actions 820′, a respective quality check reminder message 816 is generated to request a quality check, and includes an instruction to enter a user confirmation associated with the respective user action 820′ on a user interface displayed on an electronic device of a corresponding second user (e.g., a warehouse worker, a store clerk). The instruction is generated to request the corresponding second user to manually check a package prepared for the one or more items associated with the user action before shipment, delivery, or pickup of the package.

Conversely, values of the quality check factor 836 (S_{QC}) associated with a second subset of the user actions 820′ are determined not to satisfy the item check criterion 830, and items corresponding to the second subset of the user actions 820′ are not added to the quality check eligible list 826. In other words, in some embodiments, a second user action 820B is identified on one or more second information items associated with one or more second items. A second quality check factor SQ_{C2} may be generated for the second user action 820B. In accordance with a determination that the second quality check factor SQ_{C2} does not satisfy the item check criterion 830, no quality check reminder message 816 is generated to request quality check associated with the second user action 820B, and no instruction is rendered to request a user confirmation associated with the second user action 820B.

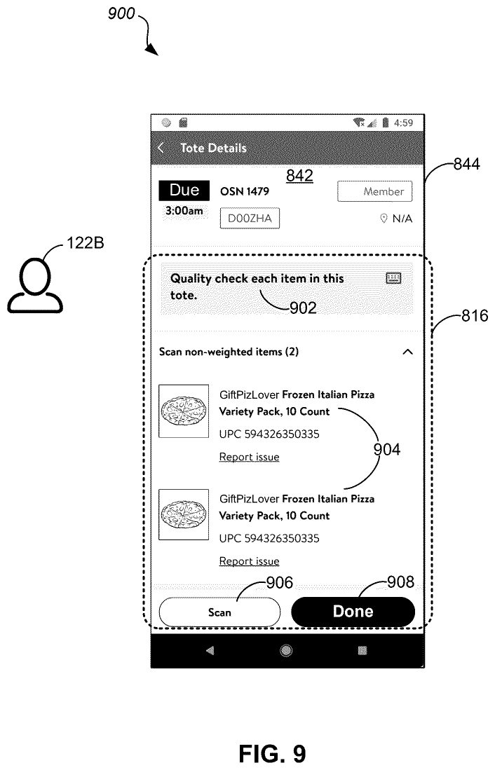

FIG. 9 is a diagram 900 illustrating a graphic user interface 842 that displays a quality check reminder message 816, in accordance with some embodiments. The quality check reminder message 816 includes an instruction to enter a user confirmation 840 associated with a user action 820 on a user interface 842 displayed on an electronic device 844 of a second user 122B. In some embodiments, the second user 122B is a store clerk or a warehouse worker. A first user 122A applies the user action 820 on an actionable information item 806 displayed on a user interface 802 of a customer's electronic device 804, and an order is generated to provide one or more items 810 corresponding to one or more information items 808 associated with the user action 820. The instruction of the quality check reminder message 816 requires a quality check on the one or more items 810 to determine each of the one or more items 810 is missing, damaged, or defective. The store clerk or warehouse worker may have prepared one or more items 810 in response to the user action 820 by himself or herself. The store clerk or warehouse worker may be assigned simply to check the one or more items 810 prepared by another worker in response to the first user's action 820. Upon reading the quality check reminder message 816 on the user interface 842, the store clerk or warehouse worker may physically check whether a package prepared in response to the user action 820 includes any missing, damaged, or defective item. Further, in some embodiments, the one or more items 810 prepared in response to the user action 820 will not be shipped, delivered, or put on shelf for a pickup before the store clerk or warehouse worker enters the user confirmation 840 on the user interface 842.

Referring to FIG. 9, in an example, the user interface 842 displays the quality check reminder message 816 including an instruction 902 (e.g., “Quality check each item in this tote”), item information 904 for two items 810 that need to be checked, an actionable information item 906 for receiving a user confirmation of starting quality check, and an actionable information item 908 for receiving a user confirmation of completing quality check. In some embodiments, the actionable information item 908 displays “Done” corresponding to a request for a user confirmation that quality check has been completed.

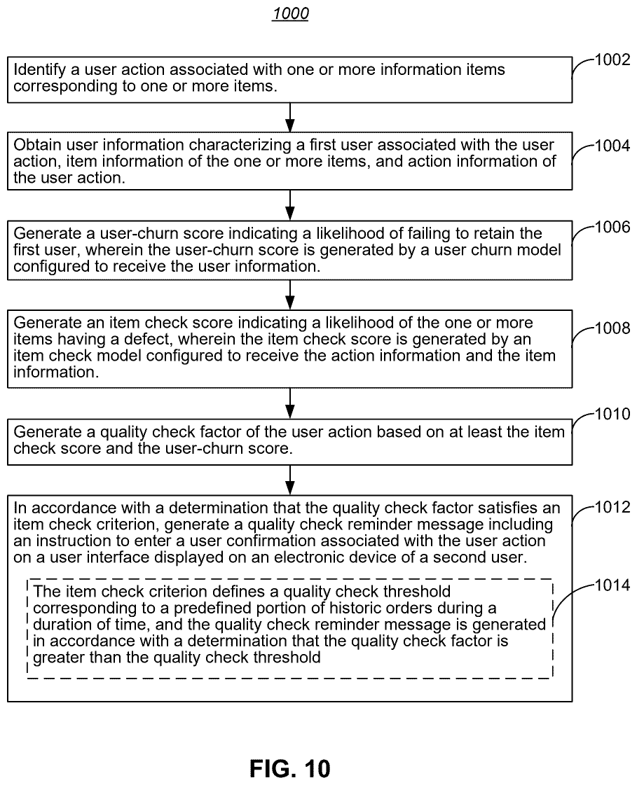

FIG. 10 is a flowchart illustrating a method for 1000 managing user actions 820 on information items 808 (e.g., providing quality check for items 810 associated with the user actions 820), in accordance with some embodiments. The method 1000 is implemented by a quality check module 222 of a system (e.g., including a computing device 102 and/or a cloud-based engine 121 in FIG. 1). Method 1000 may be governed by instructions that are stored in a non-transitory computer readable storage medium and that are executed by one or more processors of a system (e.g., a computing device 102). Each of the operations shown in FIG. 10 may correspond to instructions stored in a computer memory or non-transitory computer readable storage medium (e.g., memory 202 in FIG. 2). The computer readable storage medium may include a magnetic or optical disk storage device, solid state storage devices such as Flash memory, or other non-volatile memory device or devices. The instructions stored on the computer readable storage medium may include one or more of: source code, assembly language code, object code, or other instruction format that is interpreted by one or more processors. Some operations in method 1000 may be combined and/or the order of some operations may be changed.

A system identifies (operation 1002) a user action 820 associated with one or more information items 808 corresponding to one or more items 810 (FIG. 8B), and obtains (operation 1004) user information 818 characterizing a first user 122A associated with the user action 820, item information 824 of the one or more items 810, and action information 822 of the user action 820 (FIG. 8A). The system generates (operation 1006) a user-churn score 832 indicating a likelihood of failing to retain the first user 122A, and the user-churn score 832 is generated by a user churn model 812 configured to receive the user information 818. The system generates (operation 1008) an item check score 834 indicating a likelihood of the one or more items 810 having a defect (e.g., being missing, damaged, or defective), and the item check score 834 is generated by an item check model 814 configured to receive the action information 822 and the item information 824. The system generates (operation 1010) a quality check factor 836 of the user action 820 based on at least the item check score 834 and the user-churn score 832. In accordance with a determination that the quality check factor 836 satisfies an item check criterion 830, the system generates (operation 1012) a quality check reminder message 816 including an instruction to enter a user confirmation 840 associated with the user action 820 on a user interface 802 displayed on an electronic device 844 of a second user 122B (FIG. 8C).

In some embodiments, the item check criterion 830 defines (operation 1014) a quality check threshold QC_{TH} corresponding to a predefined portion (e.g., 2%) of historic orders during a duration of time (e.g., every day), and the quality check reminder message 816 is generated in accordance with a determination that the quality check factor 836 is greater than the quality check threshold QC_{TH}.

In some embodiments, the system applies the item check model 814 to process the action information 822 and the item information 824 jointly to generate one or more individual item scores 838. Each individual item score 838 indicates a likelihood of a respective item 810 being missing, damaged, or defective. The one or more individual item scores 838 are combined to generate the item check score 834. Further, in some embodiments, the item check model 814 includes one of a logistic regression model and a random forest model, and trained based on one of a precision-recall (PR) curve and a receiver operating characteristic (ROC) curve. Additionally, in some embodiments, the system combines the one or more individual item scores 838 by generating a logarithm based value of each individual item score 838 and generating the item check score 834 based a sum of the logarithm based values of the one or more individual item scores 838.

In some embodiments, the item check criterion 830 defines a quality check threshold QC_{TH}. The system determines a current quality check capability and adjusts the quality check threshold QC_{TH}. The quality check reminder message 816 is generated in accordance with a determination that the quality check factor 836 is greater than the adjusted quality check threshold QC_{TH}.

In some embodiments, the system identifies a second user action on one or more second information items associated with one or more second items, and generates a second quality check factor of the second user action. In accordance with a determination that the second quality check factor 836 does not satisfy the item check criterion 830, the system aborts generating a second quality check reminder message including an instruction to enter a user confirmation associated with the second user action.

In some embodiments, the quality check factor 836 is generated based on a number (N) of items 810 of the one or more items 810 associated with the user action 820. Further, in some embodiments, the quality check factor 836 is generated based on a logarithm of the number (N) of items 810 associated with the user action 820.

In some embodiments, the system determines a user-churn term based on the user-churn score 832, and an item check term based on the item check score 834. The quality check factor 836 is a weighted combination of a logarithm of the user-churn term, a logarithm of the item check term, and a logarithm of a number of items associated with the user action 820. Further, in some embodiments, the system trains the user churn model 812, the item check model 814, and weights used to determine the quality check factor 836 in an end-to-end manner based on historic transaction data.

In some embodiments, the user information 818 includes a user class to which the first user 122A is classified by a user classification model 228 based on historic interaction data of the first user 122A.

In some embodiments, the user information 818 includes one or more of: a behavior feature, a transaction feature, an engagement feature, an operational satisfaction feature, and a supplemental user feature of the first user 122A. Further, in some embodiments, the behavior feature includes at least one of: a persona class, a most recent visit time, a visit frequency, and a monetization rate. The transaction feature includes at least one of: a number of completed transactions, a gross monetization value, and an average over value. The engagement feature includes at least one of: historic search data, historic browsing or click data, historic impressions, and historic add-to-cart (ATC) data. The operational satisfaction feature includes at least one of: a number of customer care contacts and an order cancellation ratio. The supplemental user feature includes at least one of: address, phone number, age group, and gender.

In some embodiments, the action information 822 includes one or more of: an order size, an order day in a week, an order time window in a day, an order store, a store location, and an associated store-item return rate associated with the user action 820.

In some embodiments, the item information 824 of each of the one or more items 810 includes one or more of: an item quantity, a global item return rate, a global item type return rate, an item missing rate associated with an order size, an item missing rate associated with the item quantity of a respective item.

In some embodiments, the system executes a user application 218 via an Internet browser or a dedicated application, and generates instructions to display a user interface 802 on an electronic device 804 associated with the first user 122A. The user action 820 is received via the user interface 802.

In some embodiments, the second user 122B including a store clerk. The system executes a user application via a dedicated application, and generates instructions to display a user interface on an electronic device 844 associated with the store clerk. The quality check reminder message 816 is displayed on the user interface 842 for the store clerk.

It should be understood that the particular order in which the operations in FIG. 10 have been described are merely exemplary and are not intended to indicate that the described order is the only order in which the operations could be performed. One of ordinary skill in the art would recognize various ways to cache and distribute specific data as described herein. Additionally, it should be noted that details of other processes described herein with respect to FIGS. 8-13 are also applicable in an analogous manner to method 1000 described above with respect to FIG. 10. For brevity, these details are not repeated here.

Each functional component described herein can be implemented in computer hardware, in program code, and/or in one or more computing systems executing such program code as is known in the art. As discussed above with respect to FIG. 2, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 2.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of exemplary embodiments, it is not limited thereto. Rather, the appended claims should be construed broadly, to include other variants and embodiments, which can be made by those skilled in the art.

What is claimed is:

1. A system, comprising:
a non-transitory memory having instructions stored thereon; and
at least one processor operatively coupled to the non-transitory memory, and configured to read the instructions to:
identify a user action associated with one or more information items corresponding to one or more items;
obtain user information characterizing a first user associated with the user action, item information of the one or more items, and action information of the user action;
generate a user-churn score indicating a likelihood of failing to retain the first user, wherein the user-churn score is generated by a user churn model configured to receive the user information;
generate an item check score indicating a likelihood of the one or more items having a defect, wherein the item check score is generated by an item check model configured to receive the action information and the item information;
generate a quality check factor of the user action based on at least the item check score and the user-churn score; and
in accordance with a determination that the quality check factor satisfies an item check criterion, generate a quality check reminder message including an instruction to enter a user confirmation associated with the user action on a user interface displayed on an electronic device of a second user.

2. The system of claim 1, the instructions to process the action information and the item information further comprising instructions to:
apply the item check model to process the action information and the item information jointly to generate one or more individual item scores, each individual item score indicating a likelihood of a respective item being missing, damaged, or defective; and
combine the one or more individual item scores to generate the item check score.

3. The system of claim 2, wherein the item check model includes one of a logistic regression model and a random forest model, and trained based on one of a precision-recall (PR) curve and a receiver operating characteristic (ROC) curve.

4. The system of claim 2, the instructions to combine the one or more individual item scores further comprising instructions to generate a logarithm based value of each individual item score and generate the item check score based a sum of the logarithm based values of the one or more individual item scores.

5. The system of claim 1, wherein the item check criterion defines a quality check threshold corresponding to a predefined portion of historic orders during a duration of time, and the quality check reminder message is generated in accordance with a determination that the quality check factor is greater than the quality check threshold.

6. The system of claim 1, wherein the item check criterion defines a quality check threshold, the system further comprising instructions to:
determine a current quality check capability; and
adjust the quality check threshold, wherein the quality check reminder message is generated in accordance with a determination that the quality check factor is greater than the adjusted quality check threshold.

7. The system of claim 1, further comprising instructions to:
identify a second user action on one or more second information items associated with one or more second items;
generate a second quality check factor of the second user action; and
in accordance with a determination that the second quality check factor does not satisfy the item check criterion, abort generating a second quality check reminder message including an instruction to enter a user confirmation associated with the second user action.

8. The system of claim 1, wherein the user information includes a user class to which the first user is classified by a user classification model based on historic interaction data of the first user.

9. The system of claim 1, wherein the user information includes one or more of: a behavior feature, a transaction feature, an engagement feature, an operational satisfaction feature, and a supplemental user feature of the first user.

10. The system of claim 9, wherein the behavior feature includes at least one of: a persona class, a most recent visit time, a visit frequency, and a monetization rate, wherein the transaction feature includes at least one of: a number of completed transactions, a gross monetization value, and an average over value, wherein the engagement feature includes at least one of: historic search data, historic browsing or click data, historic impressions, and historic add-to-cart (ATC) data, wherein the operational satisfaction feature includes at least one of: a number of customer care contacts and an order cancellation ratio, and wherein the supplemental user feature includes at least one of: address, phone number, age group, and gender.

11. A non-transitory computer-readable storage medium, having instructions stored thereon, which when executed by one or more processors cause the processors to:
identify a user action associated with one or more information items corresponding to one or more items;
obtain user information characterizing a first user associated with the user action, item information of the one or more items, and action information of the user action;
generate a user-churn score indicating a likelihood of failing to retain the first user, wherein the user-churn score is generated by a user churn model configured to receive the user information;
generate an item check score indicating a likelihood of the one or more items having a defect, wherein the item check score is generated by an item check model configured to receive the action information and the item information;
generate a quality check factor of the user action based on at least the item check score and the user-churn score; and
in accordance with a determination that the quality check factor satisfies an item check criterion, generate a quality check reminder message including an instruction to enter a user confirmation associated with the user action on a user interface displayed on an electronic device of a second user.

12. The non-transitory computer-readable storage medium of claim 11, wherein the action information includes one or more of: an order size, an order day in a week, an order time window in a day, an order store, a store location, and an associated store-item return rate associated with the user action.

13. The non-transitory computer-readable storage medium of claim 11, wherein the item information of each of the one or more items includes one or more of: an item quantity, a global item return rate, a global item type return rate, an item missing rate associated with an order size, an item missing rate associated with the item quantity of a respective item.

14. The non-transitory computer-readable storage medium of claim 11, further comprising instructions to:
execute a user application via an Internet browser or a dedicated application; and
generate instructions to display a user interface on an electronic device associated with the first user, wherein the user action is received via the user interface.

15. The non-transitory computer-readable storage medium of claim 11, the second user including a store clerk, the non-transitory computer-readable storage medium further comprising instructions to:
execute a user application via a dedicated application; and
generate instructions to display a user interface on an electronic device associated with the store clerk, wherein the quality check reminder message is displayed on the user interface for the store clerk.

16. A method, comprising:
at a system including a non-transitory memory having instructions stored thereon and at least one processor operatively coupled to the non-transitory memory and configured to read the instructions:
identifying a user action associated with one or more information items corresponding to one or more items;
obtaining user information characterizing a first user associated with the user action, item information of the one or more items, and action information of the user action;
generating a user-churn score indicating a likelihood of failing to retain the first user, wherein the user-churn score is generated by a user churn model configured to receive the user information;
generating an item check score indicating a likelihood of the one or more items having a defect, wherein the item check score is generated by an item check model configured to receive the action information and the item information;
generating a quality check factor of the user action based on at least the item check score and the user-churn score; and
in accordance with a determination that the quality check factor satisfies an item check criterion, generating a quality check reminder message including an instruction to enter a user confirmation associated with the user action on a user interface displayed on an electronic device of a second user.

17. The method of claim 16, wherein the quality check factor is generated based on a number of items of the one or more items associated with the user action.

18. The method of claim 17, wherein the quality check factor is generated based on a logarithm of the number of items associated with the user action.

19. The method of claim 16, further comprising:
determining a user-churn term based on the user-churn score; and
determining an item check term based on the item check score,
wherein the quality check factor is a weighted combination of a logarithm of the user-churn term, a logarithm of the item check term, and a logarithm of a number of items associated with the user action.

20. The method of claim 19, further comprising training the user churn model, the item check model, and weights used to determine the quality check factor in an end-to-end manner based on historic transaction data.
